(19) United States
(12) Patent Application Publication
(10) Pub. No.: US 2026/0319940 A1
(43) Pub. Date: Oct. 15, 2026

(54) INVALIDATION PROCESSING FOR STORAGE SYSTEMS IMPLEMENTING A LOG-STRUCTURED MERGE ARCHITECTURE

(71) Applicant: Dell Products L.P., Round Rock, TX (US)

(72) Inventors: Yosef Shatsky, Karnei Shomron (IL); Ziv Dor, Nes Ziona (IL); Sabina Rachev, Herzliya (IL)

(21) Appl. No.: 19/174,597

(22) Filed: Apr. 9, 2025

(51) Int. Cl. G06F 12/02

(52) U.S. Cl. CPC G06F 12/0223; G06F 2212/1021

(57) ABSTRACT

An apparatus comprises at least one processing device configured to maintain, in memory of a storage system, a log-structured merge (LSM) data structure comprising metadata entries associated with input-output operations of the storage system, to add a new segment to the LSM data structure, to determine whether a current size of the LSM data structure meets designated threshold conditions, and, responsive to determining that the current size of the LSM data structure does not meet the designated threshold conditions, to insert metadata entries into the new segment in the LSM data structure without performing invalidations of data referenced by the metadata entries. The at least one processing device is further configured, responsive to determining that the current size of the LSM data structure meets the designated threshold conditions, to perform the invalidations of the data referenced by the metadata entries prior to inserting the metadata entries to the new segment.

### BACKGROUND

Various types of storage systems, including storage systems implementing software-defined storage (SDS) solutions, may be configured to run workloads from multiple different end-users or applications. Different end-users or applications may have different performance and feature requirements for their associated workloads. In some workloads, performance may be most important. In other workloads, capacity utilization or other feature requirements may be most important. There is thus a need for techniques which enable a storage system to offer flexibility in storage offerings for workloads with different performance and feature requirements.

### SUMMARY

Illustrative embodiments of the present disclosure provide techniques for invalidation processing for storage systems implementing a log-structured merge architecture.

In one embodiment, an apparatus comprises at least one processing device comprising a processor coupled to a memory. The at least one processing device is configured to maintain, in memory of a storage system, at least a portion of a log-structured merge data structure comprising metadata entries associated with input-output operations of the storage system, the log-structured merge data structure comprising two or more levels, a given one of the two or more levels comprising two or more segments. The at least one processing device is also configured to add a new segment to the log-structured merge data structure, to determine whether a current size of the log-structured merge data structure meets one or more designated threshold conditions and, responsive to determining that the current size of the log-structured merge data structure does not meet the one or more designated threshold conditions, to insert a set of one or more metadata entries into the new segment in the log-structured merge data structure without performing invalidations of one or more portions of the data stored in the storage system referenced by the set of one or more metadata entries. The at least one processing device is further configured, responsive to determining that the current size of the log-structured merge data structure meets the one or more designated threshold conditions, to perform the invalidations of the one or more portions of the data stored in the storage system referenced by the set of one or more metadata entries prior to inserting the set of one or more metadata entries to new segment.

These and other illustrative embodiments include, without limitation, methods, apparatus, networks, systems and processor-readable storage media.

### BRIEF DESCRIPTION OF THE DRAWINGS

FIGS. 1A and 1B schematically illustrate an information processing system comprising a storage system configured for invalidation processing for storage systems implementing a log-structured merge architecture in an illustrative embodiment.

FIG. 2 is a flow diagram of an exemplary process for invalidation processing for storage systems implementing a log-structured merge architecture in an illustrative embodiment.

FIG. 3 shows a log-structured merge data structure in an illustrative embodiment.

FIG. 4 shows a log-structured merge data structure with processed and unprocessed segments in an illustrative embodiment.

FIG. 5 schematically illustrates a framework of a server node for implementing a storage node which hosts logic for invalidation processing for a storage system implementing a log-structured merge architecture in an illustrative embodiment.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

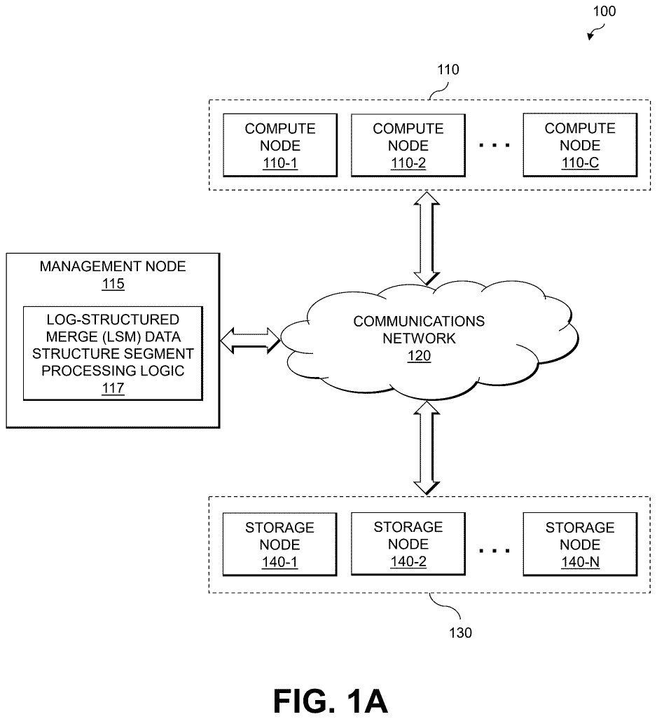

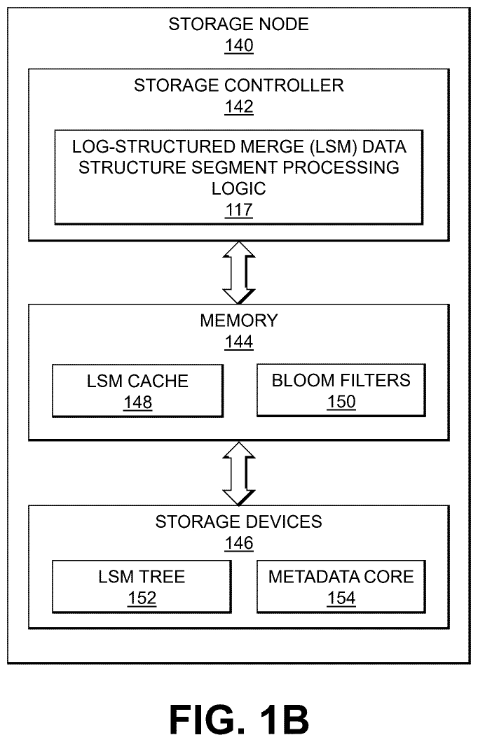

FIGS. 1A and 1B schematically illustrate an information processing system which is configured for invalidation processing for segments of a log-structured merge (LSM) data structure in a storage system implementing an LSM architecture according to an exemplary embodiment of the disclosure. More specifically, FIG. 1A schematically illustrates an information processing system 100 which comprises a plurality of compute nodes 110-1, 110-2, . . . , 110-C (collectively referred to as compute nodes 110, or each singularly referred to as a compute node 110), one or more management nodes 115 (which support a management layer of the system 100), a communications network 120, and a data storage system 130 (which supports a data storage layer of the system 100). The data storage system 130 comprises a plurality of storage nodes 140-1, 140-2, . . . , 140-N (collectively referred to as storage nodes 140, or each singularly referred to as a storage node 140). In the context of the exemplary embodiments described herein, the management nodes 115 and the data storage system 130 implement LSM data structure segment processing logic 117 supporting optimization or improvement of IO processing in the data storage system 130. FIG. 1B schematically illustrates an exemplary framework of at least one or more of the storage nodes 140.

In particular, as shown in FIG. 1B, the storage node 140 comprises a storage controller 142, a memory 144 and a plurality of storage devices 146. In general, the storage controller 142 implements data storage and management methods that are configured to divide the storage capacity of the storage devices 146 into storage pools and logical volumes. Storage controller 142 is further configured to implement LSM data structure processing logic 117 in accordance with the disclosed embodiments, as will be described in further detail below. It is to be noted that the storage controller 142 may include additional modules and other components typically found in conventional implementations of storage controllers and storage systems, although such additional modules and other components are omitted for clarity and simplicity of illustration.

The storage node 140 is assumed to implement an LSM storage architecture, in which the memory 144 includes an LSM cache 148 and a set of one or more bloom filters (BFs) 150. The LSM cache 148 provides an in-memory data structure with a limited size providing a buffer or cache for metadata for IO write operations. In some embodiments, the LSM cache 148 has a limited size and is not able to store the full LSM data structure. When the LSM cache 148 is full, data may be flushed to the storage devices 146 (e.g., using any desired cache replacement algorithm). The BFs 150 are space-efficient probabilistic data structures, which may be used to check if a given storage object is in the LSM cache 148. If a query to the BFs 150 returns a positive response, then the given storage object might be present in the LSM cache 148 (with some configurable false positive (FP) ratio). Thus, a search in the LSM cache 148 may be conducted for metadata associated with the given storage object. If the query to the BFs 150 returns a negative response, then the given storage object is definitely not in the LSM cache 148, and LSM tree 152 in the storage devices 146 may be searched directly for the given storage object (e.g., skipping a search of the LSM cache 148, providing efficiency for metadata reads). The LSM tree 152 is an example of what is more generally referred to herein as an “LSM data structure.” More generally, an LSM data structure may be any data structure or combination of data structures suitable for storing LSM-related information.

Data may also be periodically flushed from the LSM tree 152 to a metadata core data structure 154 (also referred to as metadata core 154) maintained in the storage devices 146. In some embodiments, the LSM cache 148 stores the entire LSM data structure, such that LSM tree 152 may be omitted (e.g., the entire LSM tree 152, rather than just the LSM cache 148, may be maintained in memory 144). The LSM data structure segment processing logic 117 is configured to handle addition of segments to the LSM data structure, including determining whether to process invalidations of data referenced by metadata (MD) entries inserted to new segments based on determining whether a current size of the LSM data structure meets designated threshold conditions.

In the embodiment of FIGS. 1A and 1B, the LSM data structure segment processing logic 117 may be implemented at least in part within the one or more management nodes 115 as well as in one or more of the storage nodes 140 of the data storage system 130. This may include implementing different portions of the LSM data structure segment processing logic 117 functionality described herein within the management nodes 115 and the storage nodes 140. In other embodiments, however, the LSM data structure segment processing logic 117 may be implemented entirely within the management nodes 115 or entirely within the storage nodes 140. In still other embodiments, at least a portion of the functionality of the LSM data structure segment processing logic 117 is implemented in one or more of the compute nodes 110.

The compute nodes 110 illustratively comprise physical compute nodes and/or virtual compute nodes which process data and execute workloads. For example, the compute nodes 110 can include one or more server nodes (e.g., bare metal server nodes) and/or one or more virtual machines. In some embodiments, the compute nodes 110 comprise a cluster of physical server nodes or other types of computers of an enterprise computer system, cloud-based computing system or other arrangement of multiple compute nodes associated with respective users. In some embodiments, the compute nodes 110 include a cluster of virtual machines that execute on one or more physical server nodes.

The compute nodes 110 are configured to process data and execute tasks/workloads and perform computational work, either individually, or in a distributed manner, to thereby provide compute services such as execution of one or more applications on behalf of each of one or more users associated with respective ones of the compute nodes. Such applications illustratively issue IO requests that are processed by a corresponding one of the storage nodes 140. The term “input-output” as used herein refers to at least one of input and output. For example, IO requests may comprise write requests and/or read requests directed to stored data of a given one of the storage nodes 140 of the data storage system 130.

The compute nodes 110 are configured to write data to and read data from the storage nodes 140 in accordance with applications executing on those compute nodes for system users. The compute nodes 110 communicate with the storage nodes 140 over the communications network 120. While the communications network 120 is generically depicted in FIG. 1A, it is to be understood that the communications network 120 may comprise any known communication network such as, a global computer network (e.g., the Internet), a wide area network (WAN), a local area network (LAN), an intranet, a satellite network, a telephone or cable network, a cellular network, a wireless network such as Wi-Fi or WiMAX, a storage fabric (e.g., Ethernet storage network), or various portions or combinations of these and other types of networks.

In this regard, the term “network” as used herein is therefore intended to be broadly construed so as to encompass a wide variety of different network arrangements, including combinations of multiple networks possibly of different types, which enable communication using, e.g., Transfer Control/Internet Protocol (TCP/IP) or other communication protocols such as Fibre Channel (FC), FC over Ethernet (FCoE), Internet Small Computer System Interface (iSCSI), Peripheral Component Interconnect express (PCIe), InfiniBand, Gigabit Ethernet, etc., to implement IO channels and support storage network connectivity. Numerous alternative networking arrangements are possible in a given embodiment, as will be appreciated by those skilled in the art.

The data storage system 130 may comprise any type of data storage system, or a combination of data storage systems, including, but not limited to, a storage area network (SAN) system, a network attached storage (NAS) system, a direct-attached storage (DAS) system, etc., as well as other types of data storage systems comprising software-defined storage, clustered or distributed virtual and/or physical infrastructure. The term “data storage system” as used herein should be broadly constructed and not viewed as being limited to storage systems of any particular type or types. In some embodiments, the storage nodes 140 comprise storage server nodes having one or more processing devices each having a processor and a memory, possibly implementing virtual machines and/or containers, although numerous other configurations are possible. In some embodiments, one or more of the storage nodes 140 can additionally implement functionality of a compute node, and vice-versa. The term “storage node” as used herein is therefore intended to be broadly construed, and a storage system in some embodiments can be implemented using a combination of storage nodes and compute nodes.

In some embodiments, as schematically illustrated in FIG. 1B, the storage node 140 is a physical server node or storage appliance, wherein the storage devices 146 comprise DAS resources (internal and/or external storage resources) such as hard-disk drives (HDDs), solid-state drives (SSDs), Flash memory cards, or other types of non-volatile memory (NVM) devices such non-volatile random-access memory (NVRAM), phase-change RAM (PC-RAM) and magnetic RAM (MRAM). These and various combinations of multiple different types of storage devices 146 may be implemented in the storage node 140. In this regard, the term “storage device” as used herein is intended to be broadly construed, so as to encompass, for example, SSDs, HDDs, flash drives, hybrid drives or other types of storage media. The storage devices 146 are connected to the storage node 140 through any suitable host interface, e.g., a host bus adapter, using suitable protocols such as ATA, SATA, eSATA, NVMe, NVMeOF, SCSI, SAS, etc. In other embodiments, the storage node 140 can be network connected to one or more NAS nodes over a local area network.

The storage controller 142 is configured to manage the storage devices 146 and control IO access to the storage devices 146 and/or other storage resources (e.g., DAS or NAS resources) that are directly attached or network-connected to the storage node 140. In some embodiments, the storage controller 142 is a component (e.g., storage data server) of a software-defined storage (SDS) system which supports the virtualization of the storage devices 146 by separating the control and management software from the hardware architecture. More specifically, in a software-defined storage environment, the storage controller 142 comprises an SDS storage data server that is configured to abstract storage access services from the underlying storage hardware to thereby control and manage IO requests issued by the compute nodes 110, as well as to support networking and connectivity. In this instance, the storage controller 142 comprises a software layer that is hosted by the storage node 140 and deployed in the data path between the compute nodes 110 and the storage devices 146 of the storage node 140, and is configured to respond to data IO requests from the compute nodes 110 by accessing the storage devices 146 to store/retrieve data to/from the storage devices 146 based on the IO requests.

In a software-defined storage environment, the storage controller 142 is configured to provision, orchestrate and manage the local storage resources (e.g., the storage devices 146) of the storage node 140. For example, the storage controller 142 implements methods that are configured to create and manage storage pools (e.g., virtual pools of block storage) by aggregating capacity from the storage devices 146. The storage controller 142 can divide a storage pool into one or more volumes and expose the volumes to the compute nodes 110 as virtual block devices. For example, a virtual block device can correspond to a volume of a storage pool. Each virtual block device comprises any number of actual physical storage devices, wherein each block device is preferably homogenous in terms of the type of storage devices that make up the block device (e.g., a block device only includes either HDD devices or SSD devices, etc.).

In the software-defined storage environment, each of the storage nodes 140 in FIG. 1A can run an instance of the storage controller 142 to convert the respective local storage resources (e.g., DAS storage devices and/or NAS storage devices) of the storage nodes 140 into local block storage. Each instance of the storage controller 142 contributes some or all of its local block storage (HDDs, SSDs, PCIe, NVMe and flash cards) to an aggregated pool of storage of a storage server node cluster (e.g., cluster of storage nodes 140) to implement a server-based storage area network (SAN) (e.g., virtual SAN). In this configuration, each storage node 140 is part of a loosely coupled server cluster which enables “scale-out” of the software-defined storage environment, wherein each instance of the storage controller 142 that runs on a respective one of the storage nodes 140 contributes its local storage space to an aggregated virtual pool of block storage with varying performance tiers (e.g., HDD, SSD, etc.) within a virtual SAN.

In some embodiments, in addition to the storage controllers 142 operating as SDS storage data servers to create and expose volumes of a storage layer, the software-defined storage environment comprises other components such as (i) SDS data clients that consume the storage layer and (ii) SDS metadata managers that coordinate the storage layer, which are not specifically shown in FIG. 1A. More specifically, on the client-side (e.g., compute nodes 110), an SDS data client (SDC) is a lightweight block device driver that is deployed on each server node that consumes the shared block storage volumes exposed by the storage controllers 142. In particular, the SDCs run on the same servers as the compute nodes 110 which require access to the block devices that are exposed and managed by the storage controllers 142 of the storage nodes 140. The SDC exposes block devices representing the virtual storage volumes that are currently mapped to that host. In particular, the SDC serves as a block driver for a client (server), wherein the SDC intercepts IO requests, and utilizes the intercepted IO request to access the block storage that is managed by the storage controllers 142. The SDC provides the operating system or hypervisor (which runs the SDC) access to the logical block devices (e.g., volumes).

The SDCs have knowledge of which SDS control systems (e.g., storage controller 142) hold its block data, so multipathing can be accomplished natively through the SDCs. In particular, each SDC knows how to direct an IO request to the relevant destination SDS storage data server (e.g., storage controller 142). In this regard, there is no central point of routing, and each SDC performs its own routing independent from any other SDC. This implementation prevents unnecessary network traffic and redundant SDS resource usage. Each SDC maintains peer-to-peer connections to every storage controller 142 that manages the storage pool. A given SDC can communicate over multiple pathways to all of the storage nodes 140 which store data that is associated with a given IO request. This multi-point peer-to-peer fashion allows the SDS to read and write data to and from all points simultaneously, eliminating bottlenecks and quickly routing around failed paths.

The management nodes 115 in FIG. 1A implement a management layer that is configured to manage and configure the storage environment of the system 100. In some embodiments, the management nodes 115 comprise the SDS metadata manager components, wherein the management nodes 115 comprise a tightly-coupled cluster of nodes that are configured to supervise the operations of the storage cluster and manage storage cluster configurations. The SDS metadata managers operate outside of the data path and provide the relevant information to the SDS clients and storage servers to allow such components to control data path operations. The SDS metadata managers are configured to manage the mapping of SDC data clients to the SDS data storage servers. The SDS metadata managers manage various types of metadata that are required for system operation of the SDS environment such as configuration changes, managing the SDS data clients and data servers, device mapping, values, snapshots, system capacity including device allocations and/or release of capacity, RAID protection, recovery from errors and failures, and system rebuild tasks including rebalancing.

While FIG. 1A shows an exemplary embodiment of a two-layer deployment in which the compute nodes 110 are separate from the storage nodes 140 and connected by the communications network 120, in other embodiments, a converged infrastructure (e.g., hyperconverged infrastructure) can be implemented to consolidate the compute nodes 110, storage nodes 140, and communications network 120 together in an engineered system. For example, in a hyperconverged deployment, a single-layer deployment is implemented in which the storage data clients and storage data servers run on the same nodes (e.g., each node deploys a storage data client and storage data servers) such that each node is a data storage consumer and a data storage supplier. In other embodiments, the system of FIG. 1A can be implemented with a combination of a single-layer and two-layer deployment.

Regardless of the specific implementation of the storage environment, as noted above, various modules of the storage controller 142 of FIG. 1B collectively provide data storage and management methods that are configured to perform various functions as follows. In particular, a storage virtualization and management services module may implement any suitable logical volume management (LVM) system which is configured to create and manage local storage volumes by aggregating the local storage devices 146 into one or more virtual storage pools that are thin-provisioned for maximum capacity, and logically dividing each storage pool into one or more storage volumes that are exposed as block devices (e.g., raw logical unit numbers (LUNs)) to the compute nodes 110 to store data. In some embodiments, the storage devices 146 are configured as block storage devices where raw volumes of storage are created and each block can be controlled as, e.g., an individual disk drive by the storage controller 142. Each block can be individually formatted with a same or different file system as required for the given data storage system application.

In some embodiments, the storage pools are primarily utilized to group storage devices based on device types and performance. For example, SSDs are grouped into SSD pools, and HDDs are grouped into HDD pools. Furthermore, in some embodiments, the storage virtualization and management services module implements methods to support various data storage management services such as data protection, data migration, data deduplication, replication, thin provisioning, snapshots, data backups, etc.

Storage systems, such as the data storage system 130 of system 100, may be required to provide both high performance and a rich set of advanced data service features for end-users thereof (e.g., users operating compute nodes 110, applications running on compute nodes 110). Performance may refer to latency, or other metrics such as IO operations per second (IOPS), bandwidth, etc. Advanced data service features may refer to data service features of storage systems including, but not limited to, services for data resiliency, thin provisioning, data reduction, space efficient snapshots, etc. Fulfilling both performance and advanced data service feature requirements can represent a significant design challenge for storage systems. This may be due to different advanced data service features consuming significant resources and processing time. Such challenges may be even greater in software-defined storage systems in which custom hardware is not available for boosting performance.

Device tiering may be used in some storage systems, such as in storage systems that contain some relatively “fast” and expensive storage devices and some relatively “slow” and less expensive storage devices. In device tiering, the “fast” devices may be used when performance is the primary requirement, where the “slow” and less expensive devices may be used when capacity is the primary requirement. Such device tiering may also use cloud storage as the “slow” device tier. Some storage systems may also or alternately separate devices offering the same performance level to gain performance isolation between different sets of storage volumes. For example, the storage systems may separate the “fast” devices into different groups to gain performance isolation between storage volumes on such different groups of the “fast” devices.

Illustrative embodiments provide functionality for optimizing or improving performance of storage systems which utilize LSM-based storage architectures (e.g., for LSM-based metadata updates), through intelligent handling of whether to process invalidations of metadata entries which are inserted into segments of an LSM data structure. The LSM data structure segment processing logic 117 is configured to add segments to the LSM data structure and, for each segment that is added, to determine whether a current size of the LSM data structure meets one or more designated threshold conditions. If the current size of the LSM data structure does not meet the one or more designated threshold conditions, metadata entries are inserted to the new segment without performing invalidations of portions of data (e.g., stored in the storage system) which are referenced by the overwritten metadata entries. If the current size of the LSM data structure does meet the one or more designated threshold conditions, the invalidations of the portions of the data which are referenced by the metadata entries are performed prior to inserting the metadata entries to the new segment.

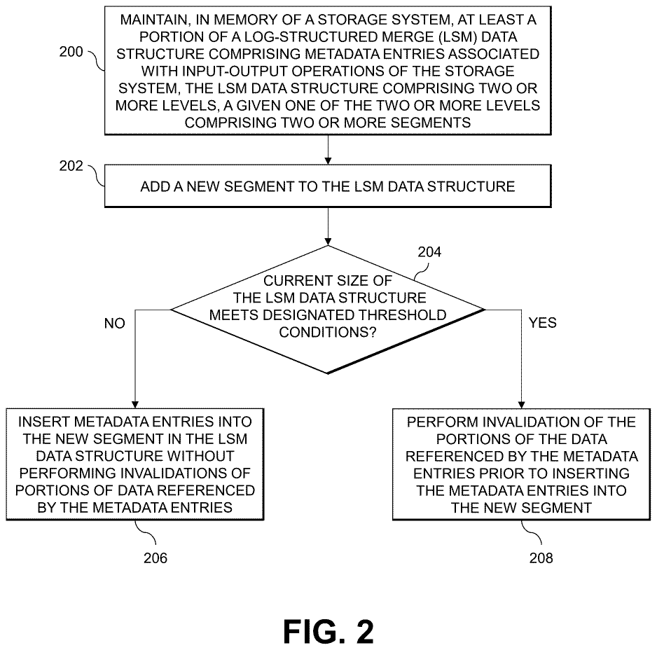

An exemplary process for invalidation processing for metadata entries inserted into segments of an LSM data structure will now be described in more detail with reference to the flow diagram of FIG. 2. It is to be understood that this particular process is only an example, and that additional or alternative processes for invalidation processing for metadata entries inserted into segments of an LSM data structure may be used in other embodiments.

In this embodiment, the process includes steps 200 through 208. These steps are assumed to be performed using the LSM data structure segment processing logic 117, which as noted above may be implemented in the management nodes 115 of system 100, in storage nodes 140 of the data storage system 130 of system 100, in compute nodes 110 of system 100, combinations thereof, etc. The process begins with step 200, maintaining, in memory of a storage system, at least a portion of an LSM data structure comprising metadata entries associated with IO operations of the storage system. The LSM data structure comprises two or more levels, a given one of the two or more levels comprising two or more segments. The two or more segments comprise time-ordered metadata entries associated with the IO operations of the storage system.

In step 202, a new segment is added to the LSM data structure. A determination is made in step 204 as to whether a current size of the LSM data structure meets one or more designated threshold conditions. Responsive to determining that the current size of the LSM data structure does not meet the one or more designated threshold conditions in step 204, a set of one or more metadata entries is inserted to the new segment in the LSM data structure in step 206 without performing invalidations of one or more portions of the data stored in the storage system referenced by the set of one or more metadata entries. Responsive to determining that the current size of the LSM data structure meets the one or more designated threshold conditions in step 204, the invalidations of the one or more portions of the data stored in the storage system referenced by the set of one or more metadata entries are performed in step 208 prior to inserting the set of one or more metadata entries to new segment.

The one or more designated threshold conditions may be dynamically updated based at least in part on (i) a current size of the LSM data structure and (ii) a current size of a core metadata store maintained by the storage system. The one or more designated threshold conditions may comprise determining whether the current size of the LSM data structure exceeds a designated size threshold. The designated size threshold may be based at least in part on a specified percentage of a current size of a core metadata store maintained by the storage system. The designated size threshold may be further based at least in part on a permissible invalidation delay parameter for the storage system.

In some embodiments, the one or more designated threshold conditions comprise determining whether the current size of the LSM data structure (i) exceeds a first designated size threshold and (ii) is less than or equal to a second designated size threshold. The first designated size threshold may comprise a limit size characterizing a size to which the LSM data structure is permitted to grow and the second designated size threshold comprises a maximum permissible size of the LSM data structure. The first designated size threshold may comprise a specified percentage of a current size of a core metadata store maintained by the storage system and the second designated size threshold may be based at least in part on an amount of memory resources allocated to the LSM data structure. The first designated size threshold may be based at least in part on a current size of a core metadata store maintained by the storage system and the second designated size threshold may be independent of the current size of the core metadata store maintained by the storage system.

Performing the invalidation of a given metadata entry in the set of one or more metadata entries may comprise: reading, from at least one existing metadata entry of at least one of (i) an existing segment of the LSM data structure and (ii) a core metadata store maintained by the storage system, information characterizing resources of the storage system utilized for storing a given portion of data referenced by the given metadata entry; and freeing the resources of the storage system utilized for storing the given portion of data referenced by the given metadata entry. Performing the invalidation of the given metadata entry in the set of one or more metadata entries may comprise refraining from overwriting the at least one existing metadata entry of the at least one of (i) the existing segment of the LSM data structure and (ii) the core metadata store maintained by the storage system, until the new segment is merged to a core metadata store maintained by the storage system. The information characterizing the resources of the storage system utilized for storing the given portion of data referenced by the given metadata entry may specify at least one data block that is deleted, and freeing the resources of the storage system may comprise marking the at least one data block as free space.

Adding the new segment to the LSM data structure may comprise merging a set of two or more segments from a first one of the two or more levels of the LSM data structure to a segment in a second one of the two or more levels of the LSM data structure.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Storage clusters and other storage systems may apply LSM techniques to optimize metadata (MD) update flows. In such systems, MD updates (e.g., MD deltas) are collected or aggregated in time-ordered contiguous LSM chunks or segments, that are periodically merged or compacted to larger chunks or segments in a next or bottom level of the LSM data structure (e.g., an LSM tree may include 2-5 levels). Merges from the bottom level of the LSM are done to a core MD store, also referred to as a MD core. This allows for reducing MD “write amplification” by avoiding or minimizing random small updates of core MD pages. Many deltas are aggregated inside the LSM data structure, and are applied to the MD core together in a single write operation in an aggregated manner.

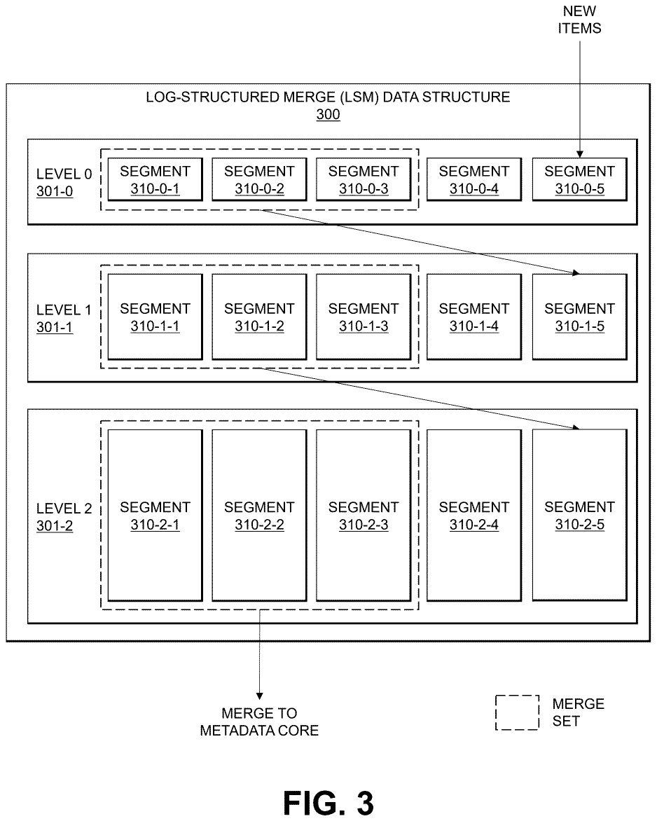

FIG. 3 shows an LSM data structure 300 including three levels-level 301-0, level 301-1 and level 301-2 (collectively, levels 301). Each of the levels 301 includes a set of segments. Level 301-0 includes segments 310-0-1, 310-0-2, 310-0-3, 310-0-4 and 310-0-5 (collectively, segments 310-0). Level 301-1 includes segments 310-1-1, 310-1-2, 310-1-3, 310-1-4 and 310-1-5 (collectively, segments 310-1). Level 301-2 includes segments 310-2-1, 310-2-2, 310-2-3, 310-2-4 and 310-2-5 (collectively, segments 310-2). New items are written to segment 310-0-5 in level 301-0. When enough items are accumulated in level 301-0, a merge set including segments 310-0-1, 310-0-1 and 310-0-2 are merged to segment 310-1-5 in level 301-1. When enough items are accumulated in level 301-1, a merge set including segments 310-1-1, 310-1-2 and 310-1-3 are merged to segment 310-2-5 in level 301-2. When enough items are accumulated in level 301-2, a merge set including segments 310-2-1, 310-2-2 and 310-2-3 are merged to a MD core.

As illustrated in FIG. 3, the LSM data structure 300 is composed of multiple levels 301, where each of the levels 301 contains multiple segments. Each segment contains ordered items (e.g., MD deltas). Multiple segments from a level i are merged into a single segment that is then placed in level i+1. The number of segments to merge is implementation-specific. In the FIG. 3 example, segments are merged in sets of 3. The group of segments which are merged together is called a merge set. The “height” of each of the segments in FIG. 3 indicates the relative size of the segments (e.g., segments 310-0 are smaller than segments 310-1, and segments 310-1 are smaller than segments 310-2). To allow for fast lookup of items in the LSM data structure 300, each segment may be associated with a BF. When segments are merged, a new BF is created for the new segment. It should be appreciated that once a merge set is merged (e.g., from one of the levels 301 to another, or from level 301-2 to the MD core), the source segments are removed from the LSM data structure 300 and their associated BFs are also removed.

The LSM data structure 300 accumulates changes which are fed to a larger “core” structure (e.g., MD core) that is not write optimized (e.g., a B-tree) and which contains the vast majority of the items. The LSM data structure 300 behaves as a type of journal to the larger MD core structure, accumulating changes to be applied to the MD core in bulk. The advantage of this is write amortization (e.g., a page in the MD core is written to serve many items in the LSM instead of only one for the case of random updates). This considerably reduces the write overhead required for MD updates. For example, if the MD core has 1 million pages and the LSM data structure 300 contains 10 million items, the worst case amortization ratio is 10:1. To improve write amortization, the LSM data structure 300 should be as large as possible.

As a write optimized structure, items are added to the LSM data structure 300 without checking what previously exists in the LSM data structure 300 or the MD core. There are likely to be previous entries in the MD core (as well as the LSM data structure 300) that become invalidated by newer entries in the LSM data structure 300. Invalidation occurs when a new entry is inserted with the same key as a previous entry. If the LSM data structure 300 is large, the LSM data structure 300 creates a significant delay in processing of the invalidation of previous items. When each entry holds on to a resource, such as capacity on disk or a memory page, these resources are not released until the previous entry is invalidated. To minimize the delay in invalidation, the LSM data structure 300 should be as small as possible.

There is a strict conflict between the interest in the LSM data structure 300 being large (e.g., to improve write amortization) and small (e.g., to minimize delay in freeing resources), and thus it is very difficult to size the LSM data structure 300 properly. For example, if it is decided that the invalidation delay should not lead to more than 1% of overall resources, this imposes a limit on the LSM data structure 300 that it cannot be larger than 1% of the MD core. This limit, however, leads to a low amortization ratio even when the MD core is very small and plenty of resources are available for the LSM data structure 300 to be larger. Consider, for example, the following configuration: (1) a MD core size of 1,000,000 (M) items; (2) a maximum unprocessed invalidations of 1%; (3) an LSM size limit of 10,000 (K) items (e.g., 1% of the 1M items in the MD core); (4) a core page size of 512 items; (5) 2K pages in the MD core (e.g., 1M items divided by the core page size of 512 items); and (6) a worst case amortization ratio of 5:1 (e.g., 10K items in the LSM divided by 2K pages in the MD core). If there are available resources for maintaining 50K items in the LSM, the amortization ratio could be 25:1 if the LSM could be larger than 1%. In some approaches, the LSM size limit is adapted based on the current workload. This, however, is still bound by the same restriction and just attempts to optimize the tradeoff.

Illustrative embodiments provide technical solutions for implementing an LSM data structure with two types of segments, referred to as “processed” and “unprocessed” segments. The unprocessed segments (also referred to as “regular” segments) are segments similar to those used in conventional implementations of an LSM data structure. The processed segments are novel, and are produced by performing a read to the MD core and executing any necessary invalidation logic within the processed segments without updating the MD core (e.g., such that only reads to the MD core are used, not writes). Items remain in the processed segments of the LSM data structure, and are merged to the MD core sometime after the processed segments are created. Advantageously, this leads to updating the MD core much less often. Given that swapping-in core pages is much cheaper from a resource consumption perspective than swapping-out core pages (e.g., reads are “cheaper” than writes), this provides significant advantages. Moreover, if resources (e.g., random-access memory (RAM) or other memory) are available, the core pages may already be in RAM leading to there being no overhead at all to retrieve the invalidated items from the core (or previous segments in the LSM data structure).

In the description below, the following notation is used. LSM_{MAX} denotes the maximal size of the LSM data structure, regardless of the current size of the MD core (e.g., 1 gigabyte (GB) of RAM). This limit will typically be derived from RAM or memory restrictions. LSM_{LIMIT} denotes the size that the LSM data structure is allowed to grow to, factoring in the current size of the MD core and invalidation delays (e.g., 1% of the MD core), where LSM_{LIMIT}≤LSM_{MAX}. LSM_{USED} denotes the actual amount of content currently in the LSM data structure, where LSM_{USED}≤LSM_{MAX}.

A process flow for implementing processed segments in an LSM data structure includes the following:
1. Determine LSM_{LIMIT} and LSM_{MAX}, both of which may change over time;
2. As long as LSM_{USED}≤LSM_{LIMIT}, add items to the LSM data structure without processing invalidations (e.g., traditional LSM behavior). Segments of this type will be “unprocessed” segments; and
3. Once LSM_{USED}>LSM_{LIMIT}, as long as LSM_{USED}≤LSM_{MAX}, segment creation is performed where inserts that expand the LSM data structure will create “processed” segments after performing invalidations. This happens at the segment level. Adding a new segment changes the size of the LSM data structure. A segment is either fully processed or fully not processed—there will not be a mix of processed and unprocessed items in the same segment. The flow to insert an item to a processed segment is as follows:
   a. Read the invalidated item from the MD core, or from an older location within the LSM data structure. If the metadata cache is large enough, this metadata page should be in RAM;
   b. Process the invalidation, which is application-specific (e.g., free resources held by the item); and
   c. Insert the new item to the processed segment.

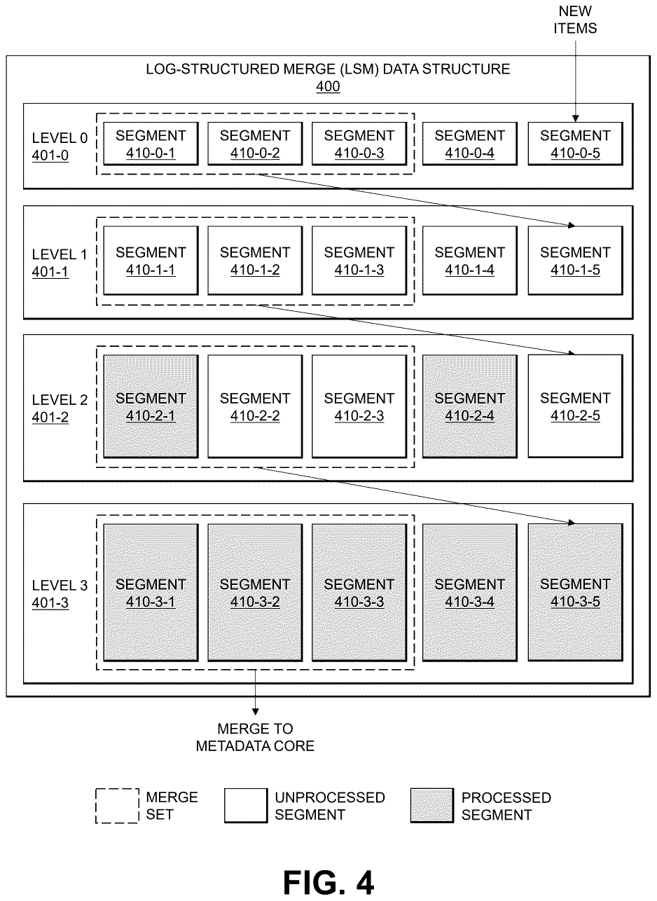

FIG. 4 shows an LSM data structure 400 with both processed and unprocessed segments. In the FIG. 4 example, the LSM data structure 400 includes four levels-level 401-0, level 401-1, level 401-2 and level 401-3 (collectively, levels 401). Each of the levels 401 includes a set of segments. Level 401-0 includes segments 410-0-1, 410-0-2, 410-0-3, 410-0-4 and 410-0-5 (collectively, segments 410-0). Level 401-1 includes segments 410-1-1, 410-1-2, 410-1-3, 410-1-4 and 410-1-5 (collectively, segments 410-1). Level 401-2 includes segments 410-2-1, 410-2-2, 410-2-3, 410-2-4 and 410-2-5 (collectively, segments 410-2). Level 401-3 includes segments 410-3-1, 410-3-2, 410-3-3, 410-3-4 and 410-3-5 (collectively, segments 410-3). New items are written to segment 410-0-5 in level 401-0. When enough items are accumulated in level 401-0, a merge set including segments 410-0-1, 410-0-1 and 410-0-2 are merged to segment 410-1-5 in level 401-1. When enough items are accumulated in level 401-1, a merge set including segments 410-1-1, 410-1-2 and 410-1-3 are merged to segment 410-2-5 in level 401-2. When enough items are accumulated in level 401-2, a merge set including segments 410-2-1, 410-2-2 and 410-2-3 are merged to segment 410-3-5 in level 401-3. When enough items are accumulated in level 401-3, a merge set including segments 410-3-1, 410-3-2 and 410-3-3 are merged to a MD core.

As illustrated in FIG. 4, the LSM data structure 400 includes unprocessed segments (e.g., segments 410-0, 410-1, 410-2-2, 410-2-3 and 410-2-5) and processed segments (e.g., 410-2-1, 410-2-4 and 410-3). LSM_{LIMIT} determines the number of unprocessed segments that the LSM data structure 400 can contain. This is represented as N full levels (in the FIG. 4 example, N=2 where level 401-0 and 401-1 include unprocessed segments 410-0 and 410-1) and M segments in Level N+1 (in the FIG. 4 example, the N+1 level, level 401-2, includes M=3 unprocessed segments 410-2-2, 410-2-3 and 410-2-5). In level 401-2, if the number of unprocessed segments is 2 or below, an unprocessed segment is created (e.g., a new segment is created when merging a merge set from level 401-1). If the number of unprocessed segments in level 401-2 is three, a processed segment is created. In some embodiments, only the oldest segments are processed. In such an approach, however, as segments are added to level 401-2, older segments may need to be converted from unprocessed to processed, which is added work. It should be noted that it is possible for a level to include both processed and unprocessed segments (e.g., level 401-2 in the LSM data structure 400, where segments 410-2-1 and 410-2-4 are processed while segments 410-2-2, 410-2-3 and 410-2-5 are unprocessed).

Whenever a segment is merged to the next level of the LSM data structure 400, or from the bottom level 401-3 of the LSM data structure 400 to the MD core, the processing of overwrites depends on the status of the segment. If the source segment is marked as “processed,” invalidated entries are simply discarded. On the other hand, if the source segment is “unprocessed,” action must be taken to handle the invalidation (e.g. if the item being deleted represents a block on a disk, that block must be marked as free). If the MD core grows to its maximum, LSM_{LIMIT} will near or potentially reach LSM_{MAX}. In the case, all segments will be unprocessed. If the MD core shrinks, once again some segments of the LSM data structure 400 will become processed.

In an LSM data structure without processed segments, the overhead of processing invalidation occurs during the merge-to-core processing (e.g., where a merge set from a bottom level of the LSM data structure is merged to a MD core), aside from some possible opportunistic invalidations detected during internal merges between levels of the LSM data structure. This makes the merge-to-core processing resource-intensive, in addition to the disadvantage of a non-ideal amortization ratio in most cases. Focusing all the processing during the merge-to-core is a disadvantage because it can create a performance dip if run too quickly, and if it runs too slowly it can lead to the LSM filling up and blocking inserts. The technical solutions described herein which enable both processed and unprocessed segments within an LSM data structure provides technical advantages through spreading the overhead of invalidation over multiple merges within the LSM data structure, in addition to the technical advantages of improved write amortization.

The technical solutions described herein provide numerous technical advantages, including improved resource utilization through utilizing all available resources to achieve a high amortization ratio without increasing the invalidation delay. In a conventional approach, merge-to-core processing is much more computationally expensive than merging to a segment, because many core pages must be updated and invalidation logic must be applied. The technical solutions described herein enable application of invalidation logic during merges to segments, which helps spread the load and make the merge-to-core processing more efficient. Thus, an LSM data structure is implemented using multiple types of segments (e.g., unprocessed and processed segments), and the technical solutions provide approaches for handling processed segments within an LSM data structure.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

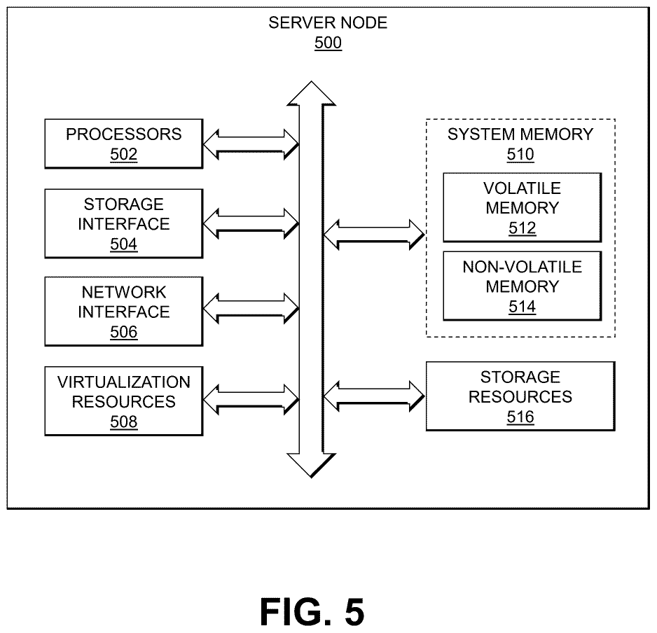

FIG. 5 schematically illustrates a framework of a server node (or more generally, a computing node) for hosting logic for invalidation processing for a storage system implementing an LSM architecture according to an exemplary embodiment of the disclosure. The server node 500 comprises processors 502, storage interface circuitry 504, network interface circuitry 506, virtualization resources 508, system memory 510, and storage resources 516. The system memory 510 comprises volatile memory 512 and non-volatile memory 514. The processors 502 comprise one or more types of hardware processors that are configured to process program instructions and data to execute a native operating system (OS) and applications that run on the server node 500.

For example, the processors 502 may comprise one or more CPUs, microprocessors, microcontrollers, application specific integrated circuits (ASICs), field programmable gate arrays (FPGAs), and other types of processors, as well as portions or combinations of such processors. The term “processor” as used herein is intended to be broadly construed so as to include any type of processor that performs processing functions based on software, hardware, firmware, etc. For example, a “processor” is broadly construed so as to encompass all types of hardware processors including, for example, (i) general purpose processors which comprise “performance cores” (e.g., low latency cores), and (ii) workload-optimized processors, which comprise any possible combination of multiple “throughput cores” and/or multiple hardware-based accelerators. Examples of workload-optimized processors include, for example, graphics processing units (GPUs), digital signal processors (DSPs), system-on-chip (SoC), tensor processing units (TPUs), image processing units (IPUs), deep learning accelerators (DLAs), artificial intelligence (AI) accelerators, and other types of specialized processors or coprocessors that are configured to execute one or more fixed functions.

The storage interface circuitry 504 enables the processors 502 to interface and communicate with the system memory 510, the storage resources 516, and other local storage and off-infrastructure storage media, using one or more standard communication and/or storage control protocols to read data from or write data to volatile and non-volatile memory/storage devices. Such protocols include, but are not limited to, non-volatile memory express (NVMe), peripheral component interconnect express (PCIe), Parallel ATA (PATA), Serial ATA (SATA), Serial Attached SCSI (SAS), Fibre Channel, etc. The network interface circuitry 506 enables the server node 500 to interface and communicate with a network and other system components. The network interface circuitry 506 comprises network controllers such as network cards and resources (e.g., network interface controllers (NICs) (e.g., SmartNICs, RDMA-enabled NICs), Host Bus Adapter (HBA) cards, Host Channel Adapter (HCA) cards, I/O adaptors, converged Ethernet adaptors, etc.) to support communication protocols and interfaces including, but not limited to, PCIe, DMA and RDMA data transfer protocols, etc.

The virtualization resources 508 can be instantiated to execute one or more services or functions which are hosted by the server node 500. For example, the virtualization resources 508 can be configured to implement the various modules and functionalities as discussed herein. In one embodiment, the virtualization resources 508 comprise virtual machines that are implemented using a hypervisor platform which executes on the server node 500, wherein one or more virtual machines can be instantiated to execute functions of the server node 500. As is known in the art, virtual machines are logical processing elements that may be instantiated on one or more physical processing elements (e.g., servers, computers, or other processing devices). That is, a “virtual machine” generally refers to a software implementation of a machine (i.e., a computer) that executes programs in a manner similar to that of a physical machine. Thus, different virtual machines can run different operating systems and multiple applications on the same physical computer.

A hypervisor is an example of what is more generally referred to as “virtualization infrastructure.” The hypervisor runs on physical infrastructure, e.g., CPUs and/or storage devices, of the server node 500, and emulates the CPUs, memory, hard disk, network and other hardware resources of the host system, enabling multiple virtual machines to share the resources. The hypervisor can emulate multiple virtual hardware platforms that are isolated from each other, allowing virtual machines to run, e.g., Linux and Windows Server operating systems on the same underlying physical host. The underlying physical infrastructure may comprise one or more commercially available distributed processing platforms which are suitable for the target application.

In another embodiment, the virtualization resources 508 comprise containers such as Docker containers or other types of Linux containers (LXCs). As is known in the art, in a container-based application framework, each application container comprises a separate application and associated dependencies and other components to provide a complete filesystem, but shares the kernel functions of a host operating system with the other application containers. Each application container executes as an isolated process in user space of a host operating system. In particular, a container system utilizes an underlying operating system that provides the basic services to all containerized applications using virtual-memory support for isolation. One or more containers can be instantiated to execute one or more applications or functions of the server node 500 as well execute one or more of the various modules and functionalities as discussed herein. In yet another embodiment, containers may be used in combination with other virtualization infrastructure such as virtual machines implemented using a hypervisor, wherein Docker containers or other types of LXCs are configured to run on virtual machines in a multi-tenant environment.

The various components of, e.g., the LSM data structure segment processing logic 117, comprise program code that is loaded into the system memory 510 (e.g., volatile memory 512), and executed by the processors 502 to perform respective functions as described herein. In this regard, the system memory 510, the storage resources 516, and other memory or storage resources as described herein, which have program code and data tangibly embodied thereon, are examples of what is more generally referred to herein as “processor-readable storage media” that store executable program code of one or more software programs. Articles of manufacture comprising such processor-readable storage media are considered embodiments of the disclosure. An article of manufacture may comprise, for example, a storage device such as a storage disk, a storage array or an integrated circuit containing memory. The term “article of manufacture” as used herein should be understood to exclude transitory, propagating signals.

The system memory 510 comprises various types of memory such as volatile RAM, NVRAM, or other types of memory, in any combination. The volatile memory 512 may be a dynamic random-access memory (DRAM) (e.g., DRAM DIMM (Dual In-line Memory Module), or other forms of volatile RAM. The non-volatile memory 514 may comprise one or more of NAND Flash storage devices, SSD devices, or other types of next generation non-volatile memory (NGNVM) devices. The system memory 510 can be implemented using a hierarchical memory tier structure wherein the volatile memory 512 is configured as the highest-level memory tier, and the non-volatile memory 514 (and other additional non-volatile memory devices which comprise storage-class memory) is configured as a lower level memory tier which is utilized as a high-speed load/store non-volatile memory device on a processor memory bus (i.e., data is accessed with loads and stores, instead of with I/O reads and writes). The term “memory” or “system memory” as used herein refers to volatile and/or non-volatile memory which is utilized to store application program instructions that are read and processed by the processors 502 to execute a native operating system and one or more applications or processes hosted by the server node 500, and to temporarily store data that is utilized and/or generated by the native OS and application programs and processes running on the server node 500. The storage resources 516 can include one or more HDDs, SSD storage devices, etc.

It is to be understood that the above-described embodiments of the disclosure are presented for purposes of illustration only. Many variations may be made in the particular arrangements shown. For example, although described in the context of particular system and device configurations, the techniques are applicable to a wide variety of other types of information processing systems, computing systems, data storage systems, processing devices and distributed virtual infrastructure arrangements. In addition, any simplifying assumptions made above in the course of describing the illustrative embodiments should also be viewed as exemplary rather than as requirements or limitations of such embodiments. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to maintain, in memory of a storage system, at least a portion of a log-structured merge data structure comprising metadata entries associated with input-output operations of the storage system, the log-structured merge data structure comprising two or more levels, a given one of the two or more levels comprising two or more segments;
to add a new segment to the log-structured merge data structure;
to determine whether a current size of the log-structured merge data structure meets one or more designated threshold conditions;
responsive to determining that the current size of the log-structured merge data structure does not meet the one or more designated threshold conditions, to insert a set of one or more metadata entries into the new segment in the log-structured merge data structure without performing invalidations of one or more portions of data stored in the storage system referenced by the set of one or more metadata entries; and
responsive to determining that the current size of the log-structured merge data structure meets the one or more designated threshold conditions, to perform the invalidations of the one or more portions of the data stored in the storage system referenced by the set of one or more metadata entries prior to inserting the set of one or more metadata entries to the new segment.

2. The apparatus of claim 1 wherein the two or more segments comprise time-ordered metadata entries associated with the input-output operations of the storage system.

3. The apparatus of claim 1 wherein the one or more designated threshold conditions are dynamically updated based at least in part on (i) a current size of the log-structured merge data structure and (ii) a current size of a core metadata store maintained by the storage system.

4. The apparatus of claim 1 wherein the one or more designated threshold conditions comprises determining whether the current size of the log-structured merge data structure exceeds a designated size threshold.

5. The apparatus of claim 4 wherein the designated size threshold is based at least in part on a specified percentage of a current size of a core metadata store maintained by the storage system.

6. The apparatus of claim 4 wherein the designated size threshold is further based at least in part on a permissible invalidation delay parameter for the storage system.

7. The apparatus of claim 1 wherein the one or more designated threshold conditions comprises determining whether the current size of the log-structured merge data structure (i) exceeds a first designated size threshold and (ii) is less than or equal to a second designated size threshold.

8. The apparatus of claim 7 wherein the first designated size threshold comprises a limit size characterizing a size to which the log-structured merge data structure is permitted to grow and the second designated size threshold comprises a maximum permissible size of the log-structured merge data structure.

9. The apparatus of claim 8 wherein the first designated size threshold comprises a specified percentage of a current size of a core metadata store maintained by the storage system and the second designated size threshold is based at least in part on an amount of memory resources allocated to the log-structured merge data structure.

10. The apparatus of claim 8 wherein the first designated size threshold is based at least in part on a current size of a core metadata store maintained by the storage system and the second designated size threshold is independent of the current size of the core metadata store maintained by the storage system.

11. The apparatus of claim 1 wherein performing the invalidation of a given metadata entry in the set of one or more metadata entries comprises:
reading, from at least one existing metadata entry of at least one of (i) an existing segment of the log-structured merge data structure and (ii) a core metadata store maintained by the storage system, information characterizing resources of the storage system utilized for storing a given portion of data referenced by the given metadata entry; and
freeing the resources of the storage system utilized for storing the given portion of data referenced by the given metadata entry.

12. The apparatus of claim 11 wherein performing the invalidation of the given metadata entry in the set of one or more metadata entries comprises refraining from overwriting the at least one existing metadata entry of said at least one of (i) the existing segment of the log-structured merge data structure and (ii) the core metadata store maintained by the storage system, until the new segment is merged to a core metadata store maintained by the storage system.

13. The apparatus of claim 11 wherein the information characterizing the resources of the storage system utilized for storing the given portion of data referenced by the given metadata entry specifies at least one data block that is deleted, and wherein freeing the resources of the storage system comprises marking the at least one data block as free space.

14. The apparatus of claim 1 wherein adding the new segment to the log-structured merge data structure comprises merging a set of two or more segments from a first one of the two or more levels of the log-structured merge data structure to a segment in a second one of the two or more levels of the log-structured merge data structure.

15. A computer program product comprising a non-transitory processor-readable storage medium having stored therein program code of one or more software programs, wherein the program code when executed by at least one processing device causes the at least one processing device:
to maintain, in memory of a storage system, at least a portion of a log-structured merge data structure comprising metadata entries associated with input-output operations of the storage system, the log-structured merge data structure comprising two or more levels, a given one of the two or more levels comprising two or more segments;
to add a new segment to the log-structured merge data structure;
to determine whether a current size of the log-structured merge data structure meets one or more designated threshold conditions;
responsive to determining that the current size of the log-structured merge data structure does not meet the one or more designated threshold conditions, to insert a set of one or more metadata entries into the new segment in the log-structured merge data structure without performing invalidations of one or more portions of data stored in the storage system referenced by the set of one or more metadata entries; and
responsive to determining that the current size of the log-structured merge data structure meets the one or more designated threshold conditions, to perform the invalidations of the one or more portions of the data stored in the storage system referenced by the set of one or more metadata entries prior to inserting the set of one or more metadata entries to the new segment.

16. The computer program product of claim 15 wherein the one or more designated threshold conditions comprises determining whether the current size of the log-structured merge data structure (i) exceeds a first designated size threshold and (ii) is less than or equal to a second designated size threshold.

17. The computer program product of claim 16 wherein the first designated size threshold comprises a limit size characterizing a size to which the log-structured merge data structure is permitted to grow and the second designated size threshold comprises a maximum permissible size of the log-structured merge data structure.

18. A method comprising:
maintaining, in memory of a storage system, at least a portion of a log-structured merge data structure comprising metadata entries associated with input-output operations of the storage system, the log-structured merge data structure comprising two or more levels, a given one of the two or more levels comprising two or more segments;
adding a new segment to the log-structured merge data structure;
determining whether a current size of the log-structured merge data structure meets one or more designated threshold conditions;
responsive to determining that the current size of the log-structured merge data structure does not meet the one or more designated threshold conditions, inserting set of one or more metadata entries to the new segment in the log-structured merge data structure without performing invalidations of one or more portions of data stored in the storage system referenced by the set of one or more metadata entries; and
responsive to determining that the current size of the log-structured merge data structure meets the one or more designated threshold conditions, performing the invalidations of the one or more portions of the data stored in the storage system referenced by the set of one or more metadata entries prior to inserting the set of one or more metadata entries to the new segment;
wherein the method is performed by at least one processing device comprising a processor coupled to a memory.

19. The method of claim 18 wherein the one or more designated threshold conditions comprises determining whether the current size of the log-structured merge data structure (i) exceeds a first designated size threshold and (ii) is less than or equal to a second designated size threshold.

20. The method of claim 19 wherein the first designated size threshold comprises a limit size characterizing a size to which the log-structured merge data structure is permitted to grow and the second designated size threshold comprises a maximum permissible size of the log-structured merge data structure.
